(19) United States
(12) Patent Application Publication
(10) Pub. No.: US 2012/0241444 A1
(43) Pub. Date: Sep. 27, 2012

(54) MICROWAVE FILTER AND MICROWAVE BRAZING SYSTEM THEREOF

(75) Inventors: Kim Yong Lim, Singapore (SN); Garimella Balaji Rao, Singapore (SN)

(73) Assignee: TURBINE OVERHAUL SERVICES PTE LTD, Jurong Town (SN)

(21) Appl. No.: 13/484,383

(22) Filed: May 31, 2012

Related U.S. Application Data
(62) Division of application No. 11/999,961, filed on Dec. 7, 2007.

(30) Foreign Application Priority Data
Oct. 26, 2007 (SN) 200717210-9

(51) Int. Cl. H05B 6/64

(52) U.S. Cl. 219/679

(57) ABSTRACT

A microwave filter for use with a microwave brazing system having a brazing chamber, a vacuum line, and a pressure gauge located proximate the vacuum line. The microwave filter comprises a baffle plate configured to be mounted in an opening between the brazing chamber and the pressure gauge, and a plurality of hollow pipes configured to substantially prevent the transmission of microwaves from the brazing chamber to the pressure gauge, and further configured to allow gas to flow between the brazing chamber and the vacuum line.

### CROSS-REFERENCE TO RELATED APPLICATION(S)

This application is a divisional application of U.S. application Ser. No. 11/999,961, filed on Dec. 7, 2007, and which claims priority to Singapore Patent Application No. 200717210-9, filed on Oct. 26, 2007, and entitled “Microwave Filter and Microwave Brazing System Thereof”, the disclosure of which is incorporated by reference in its entirety.

### BACKGROUND

The present invention relates to systems for repairing metal components, such as gas turbine engine components. In particular, the present invention relates to microwave brazing systems for repairing metal components.

Superalloys of nickel, cobalt, and iron, single crystal or equiaxed, are typically employed in gas turbine engine components due to the high mechanical strengths and creep resistances obtained with such alloys. Because gas turbine engine components are exposed to extreme temperatures and pressures, high mechanical strengths and creep resistances are required to preserve the integrity of the engine over the course of operation. However, over time, exposed portions of the components are subject to wear, cracking, and other degradations, which can lead to decreases in operational efficiencies.

Due to economic factors, it is common practice in the aerospace industry to restore turbine engine components rather than replace them. Such restorations desirably restore damaged regions of the engine components to their original dimensions. Engine cracks are typically repaired with brazing operations, which subject the single crystal alloys of the engine components to high temperatures (e.g., 1200° C./2200° F.) for extended durations (e.g., 10 hours). Exposure to the high temperatures for the extended durations, however, reduces the low-temperature (e.g., 815° C.-870° C./1500° F.-1600° F.) creep resistances of the single crystal alloys. This is believed to be due to coarsening of the gamma prime (γ′) phases of the single crystal alloys, which is measurable by increases in the average particle sizes of the γ′ phases. The reduction of the low-temperature creep resistances can cause the alloy structures of the engine components to creep under the applied temperatures and pressures during operation, thereby also reducing operational efficiencies.

One technique for restoring engine components that substantially preserves the low-temperature creep resistances of single crystal alloys involves microwave brazing. Microwave brazing uses microwave-wavelength radiation to melt and fuse a brazing alloy with the base material of the damaged engine component. The microwave brazing process reduces the duration and temperature that the base material is exposed to, thereby substantially preserving the low-temperature creep resistances of the single crystal alloys. A microwave brazing process is typically performed in a brazing chamber under vacuum to provide a uniform braze and to reduce the risk of generating glow discharges and plasmas. However, pressure gauges used to measure the reduced pressure within the brazing chamber are sensitive to the microwaves used in the microwave brazing process. This may provide erroneous pressure measurements during the microwave brazing process, thereby reducing the ability to obtain the desired vacuum environment. As such, there is a need for a system capable of providing accurate pressure measurements during microwave brazing processes.

### SUMMARY

The present invention relates to a microwave filter for use with a microwave brazing system having a brazing chamber, a vacuum line, and a pressure gauge located proximate the vacuum line. The microwave filter includes a baffle plate configured to be mounted in an opening between the brazing chamber and the pressure gauge, where the baffle plate includes a first face, a second face that opposes the first face, and a plurality of openings through the first face and the second face. The microwave filter further includes a plurality of hollow pipes extending from the second face of the baffle plate at the openings, where the plurality of hollow pipes are configured to substantially prevent the transmission of microwaves from the brazing chamber to the pressure gauge, and are further configured to allow gas to flow between the brazing chamber and the vacuum line.

### BRIEF DESCRIPTION OF THE DRAWINGS

FIG. 1 is a side schematic illustration of a microwave brazing system.

FIG. 2 is a rear perspective view of a microwave filter of the microwave brazing system.

FIG. 3 is a front view of the microwave filter of the microwave brazing system.

FIG. 4 is an expanded side schematic illustration of a portion of an alternative microwave brazing system.

FIG. 5 is a rear perspective view of a microwave filter of the alternative microwave brazing system.

### DETAILED DESCRIPTION

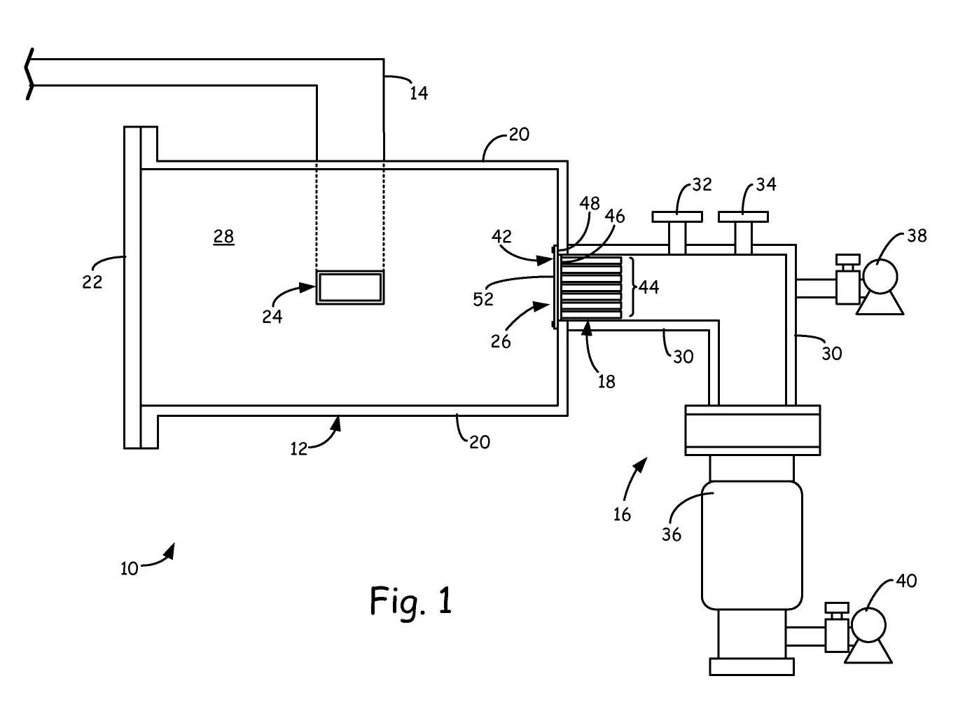

FIG. 1 is a schematic illustration of system 10, which is a microwave brazing system for repairing metal components (e.g., gas turbine engine blades and vanes) with the use of microwave-wavelength radiation (referred to herein as “microwaves”) provided from a microwave generator (not shown). System 10 includes brazing chamber 12, waveguide 14, vacuum line 16, and microwave filter 18, where microwave filter 18 is configured to substantially prevent microwaves from entering vacuum line 16 during a microwave brazing process.

Brazing chamber 12 is the portion of system 10 that retains one or more metal components (not shown) during a microwave brazing process, and includes chamber wall 20 and door 22. Chamber wall 20 is a metallic casing (e.g., steel casing) that provides an enclosed environment for the microwaves during the microwave brazing process, and includes waveguide port 24 and vacuum entrance 26. Waveguide port 24 is a first opening through chamber wall 20 that provides access to waveguide 14 for receiving the generated microwaves from the microwave generator. Vacuum entrance 26 is a second opening in chamber wall 20 that provides access to vacuum line 16, and, in the embodiment shown in FIG. 1, is the location where microwave filter 18 is secured. Door 22 is a chamber door that may be hingedly connected to chamber wall 20, where chamber wall 20 and door 22 define interior region 28. Interior region 28 is the volume within chamber wall 20 and door 22 where the metal component is placed during the microwave brazing process. Brazing chamber 12 may also include additional components (not shown), such as viewing windows and heat exchangers to further assist the microwave brazing process.

Waveguide 14 is a waveguide that interconnects brazing chamber 12 (at waveguide port 24) and the microwave generator. While illustrated with a rectangular geometry, waveguide 14 may alternatively exhibit different geometries (e.g., rectangular and circular geometries). Waveguide 14 allows the microwave generator to provide the microwaves to brazing chamber 12 for repairing the metal components with the microwave brazing process. Examples of suitable microwave generators for use with system 12 include systems configured to generate microwaves having frequencies of about 2.45 gigahertz (e.g., magnetron microwave generators).

Vacuum line 16 is a purge line for removing gases from brazing chamber 12 and includes conduit 30, pressure gauges 32 and 34, diffusion pump 36, and mechanical pumps 38 and 40. Conduit 30 is a conduit (i.e., rigid or flexible) having a first end secured to chamber wall 20 at vacuum entrance 30, and a second end secured to diffusion pump 36 with a gate valve. Pressure gauges 32 and 34 are gauges (e.g., pirani and cold cathode gauges) secured to conduit 30, and are configured to measure the pressure within conduit 30. In alternative embodiments, vacuum line 16 may include a different number of pressure gauges such that system 10 includes at least one pressure gauge to measure the pressure within vacuum line 16. Diffusion pump 36 and mechanical pumps 38 and 40 are pumps configured to purge gases from interior region 28 of brazing chamber 12 via conduit 30. Diffusion pump 36 and mechanical pumps 38 and 40 are desirably in signal communication with pressure gauges 32 and 34 via one or more process control loops (not shown), which allows pressure gauges 32 and 34 to control diffusion pump 36 and mechanical pumps 38 and 40 based on the measured pressure within conduit 30.

Microwave filter 18 is a filter disposed through vacuum entrance 26, and is configured to substantially prevent microwaves located in interior region 28 from entering conduit region 42. This prevents the microwaves used in the microwave brazing process from interfering with pressure measurements of pressure gauges 32 and 34. Microwave filter 18 includes baffle plate 42 and hollow pipes 44, where baffle plate 42 is the portion of microwave filter 18 secured to chamber wall 20, and hollow pipes 44 are supported by baffle plate 42 in a cantilevered manner within conduit 30. As discussed below, hollow pipes 44 are configured to allow gases to flow from interior region 28 of brazing chamber 12 to conduit 30. As such, the pressure within conduit 30 is the same as the pressure of interior region 28. This allows pressure gauges 32 and 34 to effectively measure the pressure within interior region 28 while being isolated from the microwaves located within interior region 28. While microwave filter 18 is disposed at vacuum entrance 26 in the embodiment shown in FIG. 1, microwave filter 18 may alternatively be secured to different components of system 10 so long as microwave filter 18 is disposed between interior region 28 and pressure gauges 32 and 34.

During a brazing process, door 22 is opened and a metal component containing a brazing alloy (not shown) is inserted within interior region 28. Examples of suitable metal components, brazing alloys, and techniques for applying the brazing alloys for a microwave brazing process are discussed in Garimella, U.S. Patent Application Publication No. 2006/0071053, which is hereby incorporated in full by reference. Door 22 is then closed, and the gases (e.g., air) are then pumped from interior region 28 of brazing chamber 12 with diffusion pump 36 and mechanical pumps 38 and 40. Pressure gauges 32 and 34 measure the pressure within conduit 30 and identify when a desired pressure is obtained. As discussed above, performing the microwave brazing process under reduced pressure (e.g., vacuum) provides a uniform braze to the metal component and reduces the risk of generating glow discharges and plasmas. Examples of suitable pressures for performing the microwave brazing process include about 13 millipascals (about 10⁻⁴ Torr) or less, with more particularly suitable pressures including about 1.3 millipascals (about 10⁻⁵ Torr) or less.

After the desired reduced pressure is obtained, pressure gauges 32 and 34 continue to measure the pressure within conduit 30, which corresponds to the pressure within interior region 28. If the pressure within interior region 28 and conduit 30 changes due to the microwave brazing process, pressure gauges 32 and 34 desirably adjust the pumping intensities of diffusion pump 36 and/or mechanical pumps 38 and 40 to stabilize the pressure at the desired reduced pressure.

The microwave generator then emits microwaves to interior region 28 of brazing chamber 12 via waveguide 14 and waveguide port 24 to initiate the microwave brazing process. The microwaves heat the metal component and the brazing alloy as discussed in Garimella, U.S. Patent Application Publication No. 2006/0071053, thereby allowing the brazing alloy to interdiffuse into the base material of the metal component. Upon entrance to brazing chamber 12, the microwaves bounce off metallic obstructions, such as the metal component, the brazing alloy, chamber wall 20, and door 22. As such, portions of the reflected microwaves attempt to enter conduit 30 via vacuum entrance 26. However, as discussed below, microwave filter 18 substantially prevents the microwaves from entering conduit 30. As used herein, the term “substantially prevents” with respect to the flux of microwaves across microwave filter 18 refers to less than about 1% of the microwaves penetrating through microwave filter 18. Such levels of microwave penetration do not provide observable interferences of pressure measurements with pressure gauges 32 and 34.

Substantially preventing the microwaves entering conduit 30 correspondingly prevents the microwaves from interfering with pressure gauges 32 and 34. If substantial concentrations of microwaves were otherwise allowed to contact pressure gauges, such as pirani gauges and cold cathode gauges, the microwaves may disrupt the pressure measurements, thereby providing erroneous signals to the process control loops controlling diffusion pump 36 and mechanical pumps 38 and 40. For example, a pirani gauge typically incorporates a metallic wire that is heated with an electrical current and is cooled by the gas in a chamber, where the rate of cooling is dependent on the concentration of the gas in the chamber. If the metallic wire is exposed to the microwaves, the microwaves may heat the metallic wire, thereby providing a false temperature reading indicating that the pressure is lower than the actual pressure within conduit 30.

Similarly, a cold cathode gauge measures electrical ions produced when the gas in a chamber is bombarded with electrons, where the number of electrical ions produced is dependent on the concentration of the gas in the chamber. Microwave interference with the cold cathode gauge may result in false identification of electrical ions, which indicates that the pressure is greater than the actual pressure within conduit 30. Accordingly, microwave filter 18 allows pressure gauges 32 and 34 to effectively measure the pressure within brazing chamber 12, while also substantially preventing the microwaves from entering vacuum line 16, thereby preventing interference with pressure gauges 32 and 34. As a result, the pressure within brazing chamber 12 may be accurately measured during the microwave brazing process.

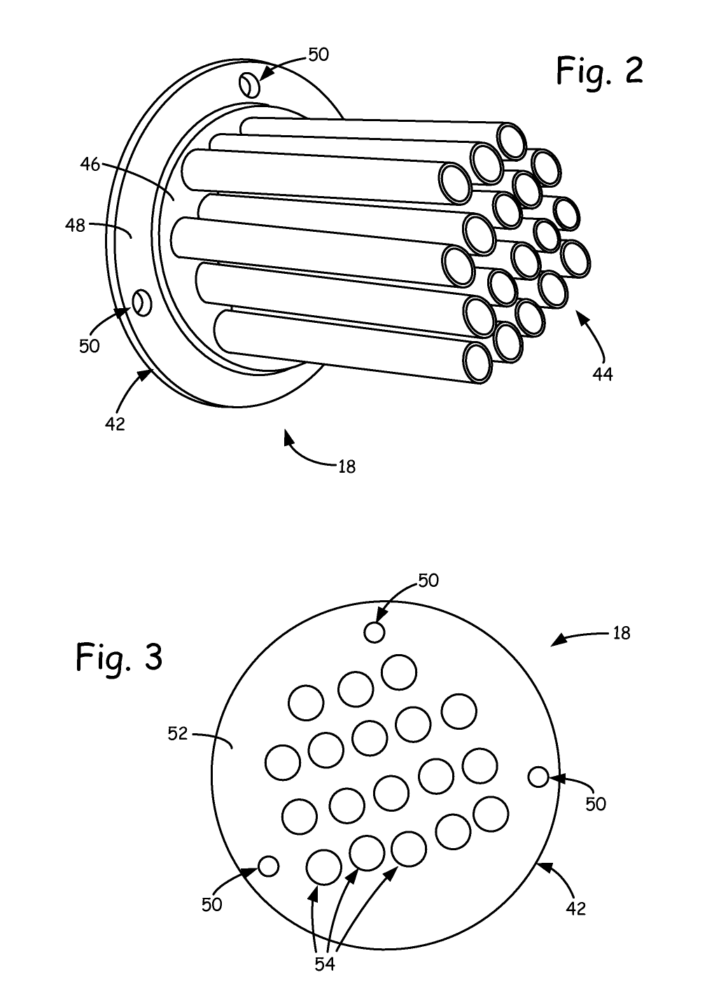

FIG. 2 is a rear perspective view of microwave filter 18, further illustrating baffle plate 42 and hollow pipes 44. As shown, baffle plate 42 includes inner rear face 46, outer rear face 48, and bolt holes 50, where inner rear face 46 is the portion of baffle plate 42 that faces conduit 30 (shown in FIG. 1). Outer rear face 48 is the portion of baffle plate 42 that is disposed against chamber wall 20 (shown in FIG. 1) for securing microwave filter 18 to chamber wall 20 via bolts (not shown) extending through bolt holes 50.

Hollow pipes 44 are a plurality of elongated, hollow pipes extending from inner rear face 46. As discussed above, hollow pipes 46 allow the passage of gases from brazing chamber 12 (shown in FIG. 1) to conduit 30, but substantially prevent the transmission of the microwaves. As the microwaves from brazing chamber 12 enter hollow pipes 44, the microwaves continuously reflect off the inner surfaces of hollow pipes 44. For a given microwave, each reflection converts a portion of the energy of the microwave into heat. Thus, the successive reflections within hollow pipes 44 continuously reduce the energy levels of the microwaves until the microwaves do not have enough remaining energy to further reflect. Accordingly, each of hollow pipes 44 desirably has a length-to-diameter ratio that is suitable for substantially preventing the transmission of microwaves, and that allows a suitable gas flow for balancing the pressures between brazing chamber 12 and conduit 30.

As used herein with respect to a pipe of a microwave filter (e.g., hollow pipes 44 of microwave filter 18), the term “diameter” refers to the average inner diameter of the pipe, where the average inner diameter is taken along the length of the pipe. The actual dimensions of hollow pipes 44 may vary depending on multiple factors, such as the size of conduit 30 and the number of hollow pipes 44. In the embodiment shown in FIG. 2, hollow pipes 44 have circular cross sections. In alternative embodiments, hollow pipes 44 may have cross sections with different geometric dimensions (e.g., oval and rectangular).

Examples of suitable length-to-diameter ratios for each of hollow pipes 44 include ratios of at least about 6-to-1, with particularly suitable length-to-diameter ratios including ratios of at least about 10-to-1, and with even more particularly suitable length-to-diameter ratios including ratios of at least about 20-to-1. Examples of suitable lengths for each of hollow pipes 44 from inner rear face 46 range from about 5 centimeters to about 50 centimeters, with particularly suitable lengths ranging from about 10 centimeters to about 20 centimeters. While microwave filter 18 is shown in FIG. 2 with 18 hollow pipes 44, microwave filter 18 may alternatively include greater and fewer numbers of hollow pipes 44 depending on the dimensions of hollow pipes 44 and the cross-sectional area of conduit 30. Examples of suitable numbers of hollow pipes 44 range from 5 pipes to 50 pipes, with particularly suitable numbers of hollow pipes 44 ranging from 10 pipes to 30 pipes, and with even more particularly suitable numbers of hollow pipes 44 ranging from 15 pipes to 25 pipes.

FIG. 3 is a front view of microwave filter 18, where baffle plate 42 further includes front face 52 and pipe openings 54. Front face 52 is the portion of microwave filter 18 that faces interior region 28 of brazing chamber 12 (shown in FIG. 1), and is the opposing face of inner and outer rear faces 46 and 48 (shown in FIG. 2). Pipe openings 54 are holes within front face 52 that substantially align with the diameters of hollow pipes 44 (shown in FIG. 2). This allows the gases to flow through microwave filter 18 to balance the pressures between brazing chamber 12 and conduit 30 (shown in FIG. 1). As discussed above, this allows pressure gauges 32 and 34 to effectively measure the pressure of interior region 28 while being isolated from the microwaves located within interior region 28.

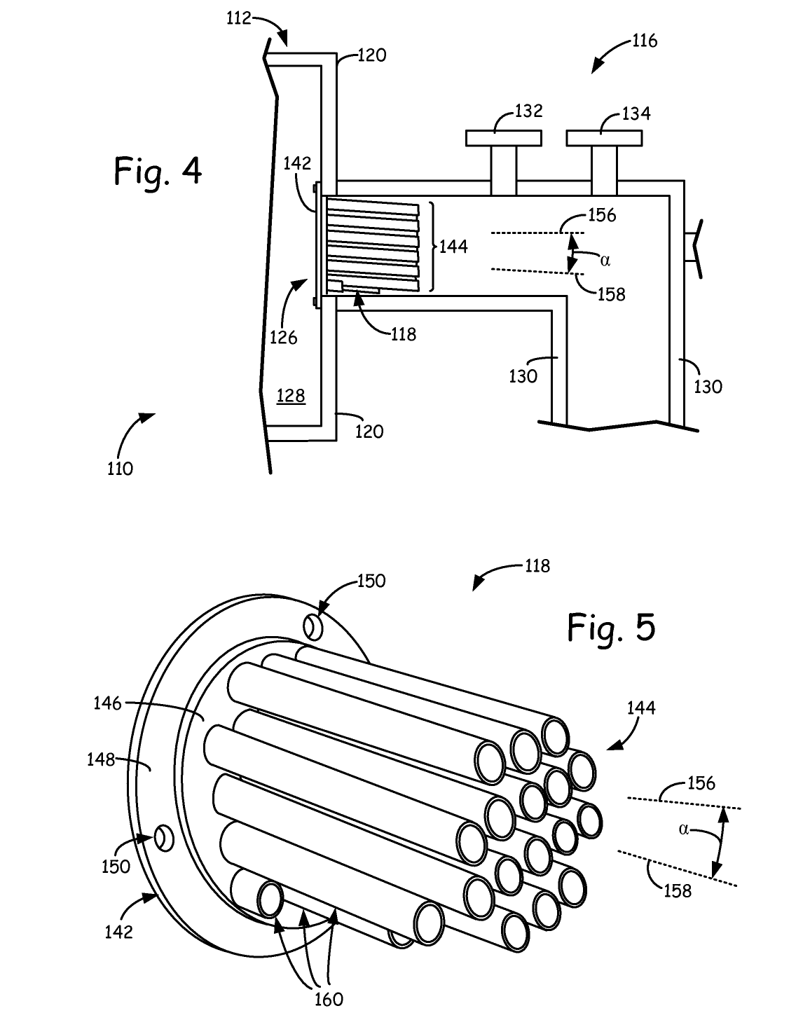

FIG. 4 is an expanded side schematic illustration of a portion of system 110, which is an alternative microwave brazing system to system 10 (shown in FIG. 1) and functions in the same manner for performing microwave brazing processes, where the corresponding reference labels are increased by “100”. As shown in FIG. 4, microwave filter 118 includes baffle plate 142 and hollow pipes 144, where hollow pipes 144 extend at an angle that directs hollow pipes 144 away from pressure gauges 132 and 134. In this embodiment, baffle plate 142 is orthogonal to longitudinal axis 156, which is generally parallel to the portion of conduit 130 that microwave filter 118 is disposed in. In comparison, hollow pipes 144 extend along offset axis 158, where offset axis 158 is disposed at an angle α to longitudinal axis 156. Thus, hollow pipes 144 extend away from pressure gauges 132 and 134. Accordingly, any transient microwaves that transmit through microwave filter 118 are directed away from pressure gauges 132 and 134, thereby further reducing the risk of microwaves interfering with pressure gauges 132 and 134. Examples of suitable angles α for offset axis 158 relative to longitudinal axis 156 range from greater than zero degrees to less than about 30 degrees, with particularly suitable angles α ranging from about 5 degrees to about 15 degrees.

FIG. 5 is a rear perspective view of microwave filter 118, further illustrating the arrangement of hollow pipes 144. As shown, a portion of hollow pipes 144 (referred to as hollow pipes 160) are shorter than the majority of hollow pipes 144. Because hollow pipes 144 are oriented at angle α relative to longitudinal axis 156, if each of hollow pipes 144 had a length-to-diameter ratio corresponding to the above-discussed suitable length-to-diameter ratios, a portion of hollow pipes 144 would not fit within conduit 30. As such, hollow pipes 160 have lower length-to-diameter ratios to allow microwave filter 118 to fit within conduit 30. While the lower length-to-diameter ratios may not entirely prevent transmission of the microwaves through hollow pipes 160, the energy levels of the microwaves are partially reduced to reduce the affect of such microwaves on pressure gauges 132 and 134. In an alternative embodiment, hollow pipes 160 may be omitted and baffle plate 142 may be sealed at the locations of hollow pipes 160, thereby preventing the transmission of microwaves at such locations.

Although the present invention has been described with reference to preferred embodiments, workers skilled in the art will recognize that changes may be made in form and detail without departing from the spirit and scope of the invention.

1. A microwave brazing system comprising:
a brazing chamber having a chamber wall;
a first opening disposed through the chamber wall and configured to relay microwaves from a microwave generator;
a second opening disposed through the chamber wall;
a conduit connected to the brazing chamber at the second opening;
at least one pressure gauge secured to the conduit, and configured to measure pressure within the conduit; and
a microwave filter disposed between the brazing chamber and the at least one pressure gauge, the microwave filter comprising a plurality of hollow pipes configured to substantially prevent the transmission of microwaves from the brazing chamber to the conduit, while allowing gas to flow between the brazing chamber and the conduit.

2. The microwave brazing system of claim 1, wherein the microwave filter further comprises a baffle plate secured to the chamber wall, wherein the plurality of hollow pipes are secured to the baffle plate and extend into the conduit.

3. The microwave brazing system of claim 2, wherein the plurality of hollow pipes extend at an angle to an axis that is orthogonal to the second face of the baffle plate.

4. The microwave brazing system of claim 3, wherein the plurality of hollow pipes are a first plurality of hollow pipes, and wherein the microwave filter further comprises a second plurality of hollow pipes having length-to-diameter ratios that are less than length-to-diameter ratios of the first plurality of hollow pipes.

5. The microwave brazing system of claim 1, wherein the plurality of hollow pipes comprise a number of hollow pipes ranging from 5 pipes to 50 pipes.

6. The microwave brazing system of claim 1, wherein the plurality of hollow pipes have length-to-diameter ratios of at least about 6-to-1.

7. The microwave brazing system of claim 1, further comprising at least one pump connected to the conduit for reducing the pressure within the conduit.
